(19) United States
(12) Patent Application Publication
(10) Pub. No.: US 2014/0114837 A1
(43) Pub. Date: Apr. 24, 2014

(54) Systems And Methods For Automated Tenant Screening From Rental Listing Ad

(71) Applicant: Digital Technology, Ltd., Louisville, CO (US)

(72) Inventors: Joseph L. Buczkowski, Louisville, CO (US); Jitka Bedford, Lafayette, CO (US); Christopher Thasiah, Erie, CO (US); Gregory C. Frommer, Thornton, CO (US); Michael C. Hoppis, Superior, CO (US)

(21) Appl. No.: 14/056,397

(22) Filed: Oct. 17, 2013

Related U.S. Application Data
(60) Provisional application No. 61/715,517, filed on Oct. 18, 2012.

(51) Int. Cl. G06Q 30/06

(52) U.S. Cl. CPC G06Q 30/0645
USPC 705/38

(57) ABSTRACT

Systems and methods for automated tenant screening from a rental listing ad preferably includes a combination of structure and/or function whereby an internet server has an interface to receive information from and to provide information to (i) an on-line tenant server and (ii) an on-line third party tenant screening server. A memory stores details of at least one rental property. At least one processor is configured to (i) provide to the on-line tenant server one or more web pages showing the stored details of the at least one rental property, in response to an inquiry from the on-line tenant server, (ii) receive from the on-line tenant server a screening request in response to a tenant request made through the one or more web pages, (iii) provide the tenant screening request to the third party tenant screening server, (iv) receive from the third party tenant screening server a screening-result, (v) provide to the tenant server the screening-result through the one or more web pages, and (vi) accept through the one or more web pages a tenant rental application corresponding to the stored details of the at least one rental property.

This application claims priority to U.S. Provisional Patent Appln. No. 61/715,517, filed Oct. 18, 2012, the entire contents of which are incorporated herein by reference.

### BACKGROUND OF THE INVENTION

1. Field of the Invention

The present invention relates generally to systems and methods for automatic management of rental properties. More particularly, the invention concerns systems and methods that automate the application and tenant screening process commenced from a rental listing ad or link posted on the internet.

2. Description of the Background Art

Landlords routinely post rental listing ads on the internet as a convenient and effective way of marketing rental properties. Renters commonly search the internet for properties available for lease. The problem for landlords and renters is that there is no way for a renter to submit his or her rental application and tenant screening report to the landlord directly from the internet listing ad. The present invention solves this problem, leveraging the internet to save landlords and renters both time and money. Furthermore, the present invention significantly enhances the functional value of internet rental listing ads.

Until now, technical and legal challenges prevented renters from submitting application and tenant screening data to the landlord directly from a listing ad. The technical challenges included connecting landlords, renters, credit reporting agencies, and listing portals in such a way as to facilitate listing ad creation and publication and to exchange the necessary data between the parties to complete application and tenant screening. Restrictions on the transmission of credit report data imposed by the Fair Credit Reporting Act impose additional technical complications. Other technical challenges include retrieving credit report information from multiple data sources, and providing landlords with the necessary tools to administer and manage their rental listings, given the complexities created by adding access to the rental application and tenant screening directly from the listing ad.

The present invention solves these challenges by providing a website through which landlords can create and publish listing ads that contain the technology to allow renters to submit applications and tenant screening reports directly from the ad. The present invention accomplishes this by adding buttons and links to listing ads that, when activated by the renter, initiate processes and data retrieval and transmission so that the landlord can access and review a renter's information for purposes of making a leasing decision.

The present invention may be used independently or as a part of a larger web-based property management platform that provides leasing services. The larger platform may provide services for listing ads, digital applications, tenant screening, e-signature leases, and electronic rent collection.

### SUMMARY OF THE INVENTION

It is an object of the subject disclosure to overcome the disadvantages noted above and to provide apparatus and method for providing a web-based tool for landlords, renters, and screening institutions to exchange information and effect leases.

According to a first aspect of the present invention, systems and methods for automated tenant screening from a rental listing ad preferably includes an internet server having an interface to receive information from and to provide information to (i) an on-line tenant server and (ii) an on-line third party tenant screening server. A memory stores details of at least one rental property. At least one processor is configured to (i) provide to the on-line tenant server one or more web pages showing the stored details of the at least one rental property, in response to an inquiry from the on-line tenant server, (ii) receive from the on-line tenant server a screening request in response to a tenant request made through the one or more web pages, (iii) provide the tenant screening request to the third party tenant screening server, (iv) receive from the third party tenant screening server a screening-result, (v) provide to the tenant server the screening-result through the one or more web pages, and (vi) accept through the one or more web pages a tenant rental application corresponding to the stored details of the at least one rental property.

### BRIEF DESCRIPTION OF THE DRAWINGS

These and other advantages of the present invention will be readily understood with reference to the following specifications and attached drawings.

FIG. 1 is a schematic block diagram showing features according to the preferred embodiment.

FIG. 2 is a screenshot of an exemplary home page in accordance with the present invention.

FIG. 3 is a screenshot of an exemplary dashboard in accordance with the present invention.

FIG. 4 is a screenshot of an exemplary listing ad data input form in accordance with the present invention.

FIG. 5 is a screenshot showing sections of FIG. 4.

FIG. 6 is a screenshot of an exemplary photo optimize page in accordance with the present invention.

FIG. 7 is a screenshot of an exemplary page that displays the listing ad preview in accordance with the present invention.

FIG. 8 shows a screenshot of the post-your-listing page in accordance with the present invention.

FIG. 9 shows a screenshot of posting an ad on craigslist in accordance with the present invention.

FIG. 10 shows a screenshot of listing ad summary in accordance with the present invention.

FIG. 11 is a screenshot showing that the Landlord is no longer accepting applications.

FIG. 12 is a screenshot showing that the listing ad has been removed.

FIG. 13 is a screenshot showing the Renter application Start page, according to the preferred embodiment.

FIG. 14 is a screenshot of an exemplary email page from which the Renter may be taken to the rental application.

FIG. 15 shows an exemplary rental application. shows

FIG. 15 shows an exemplary rental application, according to the preferred embodiment.

FIG. 16 is a screenshot of a renter receipt for the Renter's credit check, according to the preferred embodiment.

FIG. 17 is a screenshot of a rental application receipt for the Renter, according to the preferred embodiment.

FIG. 18 is a screenshot of a credit report release authorization, according to the preferred embodiment.

FIG. 19 is a screenshot of an application completion notification email sent to the landlord, according to the preferred embodiment.

### DETAILED DESCRIPTION OF THE PRESENTLY PREFERRED EXEMPLARY EMBODIMENTS

For purposes of explanation, specific configurations and details are set forth in order to provide a thorough understanding of the present invention. However, it will be apparent to one skilled in the art that the present invention may be practiced without the specific details herein. Furthermore, well known features may be omitted or simplified in order not to obscure the present invention.

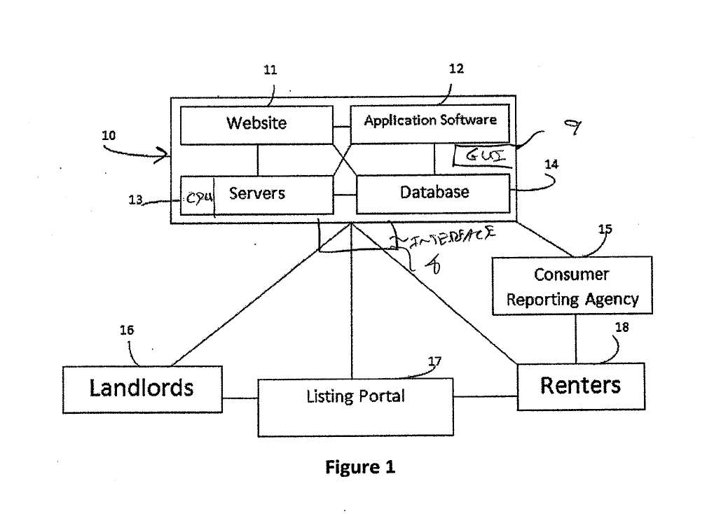

A Description of the Parties. FIG. 1 illustrates a schematic view of a system for automated tenant screening from a rental listing ad in accordance with the present invention. The system 10 preferably comprises a website 11, composed of an interface 8, a graphical user interface 9, one or more servers 13 (each comprising one or more processors, CPU, ROM, RAM, interfaces, power supplies, etc.), application software 12, and one or more databases 14. The system 10 connects to landlords 16 (preferably through one or more on-line landlord servers and/or personal computers), renters 18 (preferably through one or more on-line tenant or renter servers and/or personal computers), listing portals 17 (comprising one or more servers), and credit (consumer) reporting agencies 15 (again, comprising one or more servers) through the internet. For purposes of this application, it is useful to define the parties connected by the system 10. “Landlords” 16 means property owners, their agents, or other users of the system 10 that build rental listing ads to market on the internet. “Renters” 18 means people searching internet rental listing ads with the intent to lease a property. “Consumer Reporting Agency” 15 means any person or company, such as TransUnion, that provides consumer credit information to third parties. “Listing Portals” 17 means any website, such as craigslist.org, that displays rental listing ads.

The present invention provides a website 11 through which Landlords 16 can create listing ads that contain the technology and connections to facilitate tenant screening from a listing ad, with the intent to post them on a Listing Portal 17.

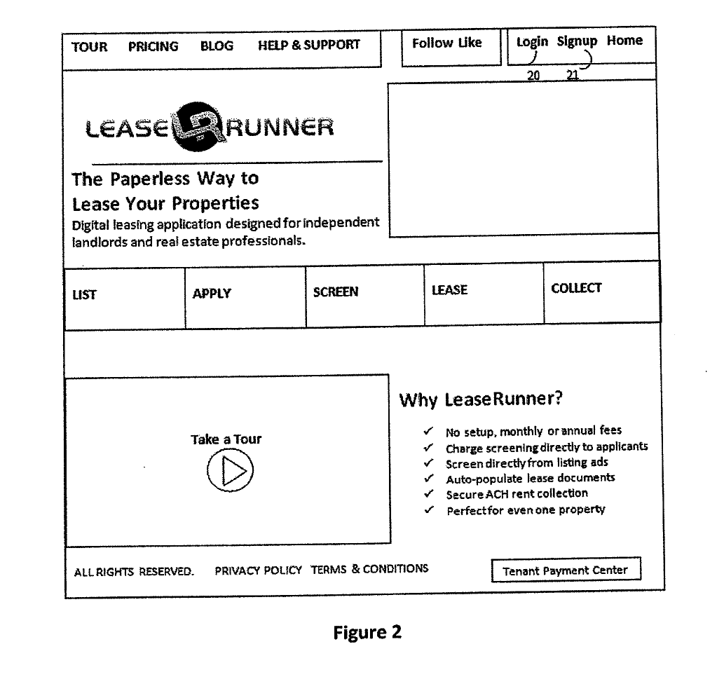

The Homepage. FIG. 2 is a screenshot of an exemplary home page in accordance with the present invention. The page may comprise a link to a sign-up page 21, so that a Landlord 16 may sign up for an account, create listing ads, manage properties 306, and otherwise transact business through the website 11. The sign-up page 21 gathers the name, email address, login name(s), and other information as is customarily done to create an account on an internet website. The Landlord's 16 information is stored in the database 14. A submit button on the sign-up page 21 emails the Landlord 16 a password, enabling the Landlord 16 to sign in to the website 11 by clicking the login link 20 and entering the Landlord's 16 username and password. The login link 20 allows for existing Landlord 16 customers to sign in to the website 11.

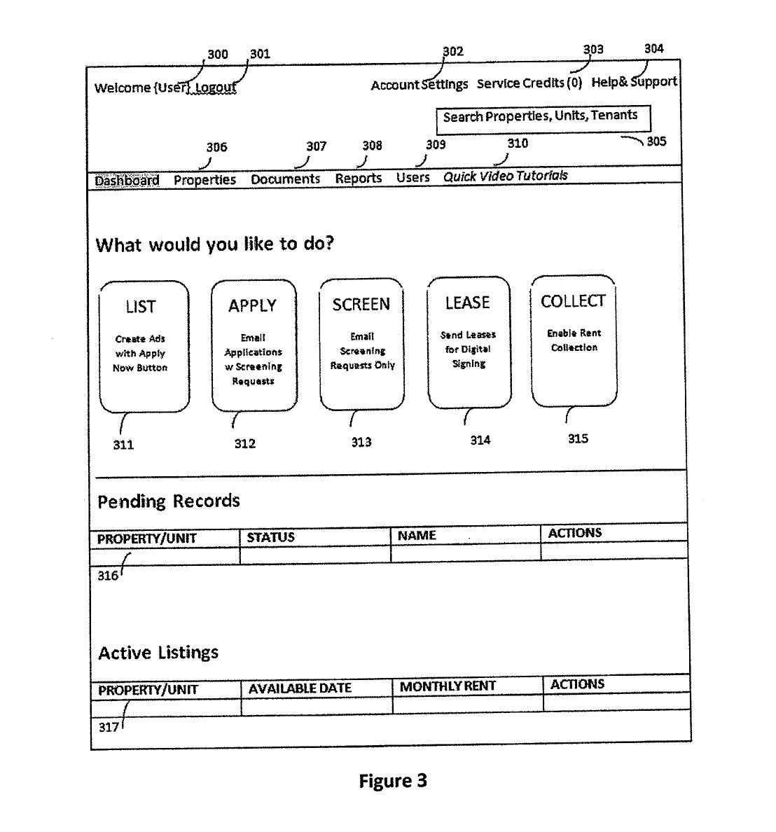

The Dashboard. FIG. 3 is a screenshot of an exemplary dashboard that a Landlord 16 sees upon logging into the website 11. The dashboard displays links and information useful to the Landlord 16 to create listing ads, manage properties 306, and otherwise transact business. The dashboard displays the Landlord's name 300 and logout link 301. It displays links to account settings 302, service credit information 303, and help and support 304. It displays a search function 305, allowing the landlord to search properties, units, tenants, and other information. The dashboard contains links to properties 306, documents 307, reports 308, users 309, and video tutorials 310. The dashboard contains action buttons to initiate services, such as creating listing ads 311, emailing applications 312 and/or screening requests 313, building lease documents 314, emailing lease documents for e-signature 314, and enabling electronic rent collection 315. The dashboard provides information in table format, such as pending records 316 and active listing ads 317. Clicking on the list action button 311 begins the process to create and publish a rental listing ad with optional automated tenant screening. The layout and functionality of the dashboard could change over time as needed.

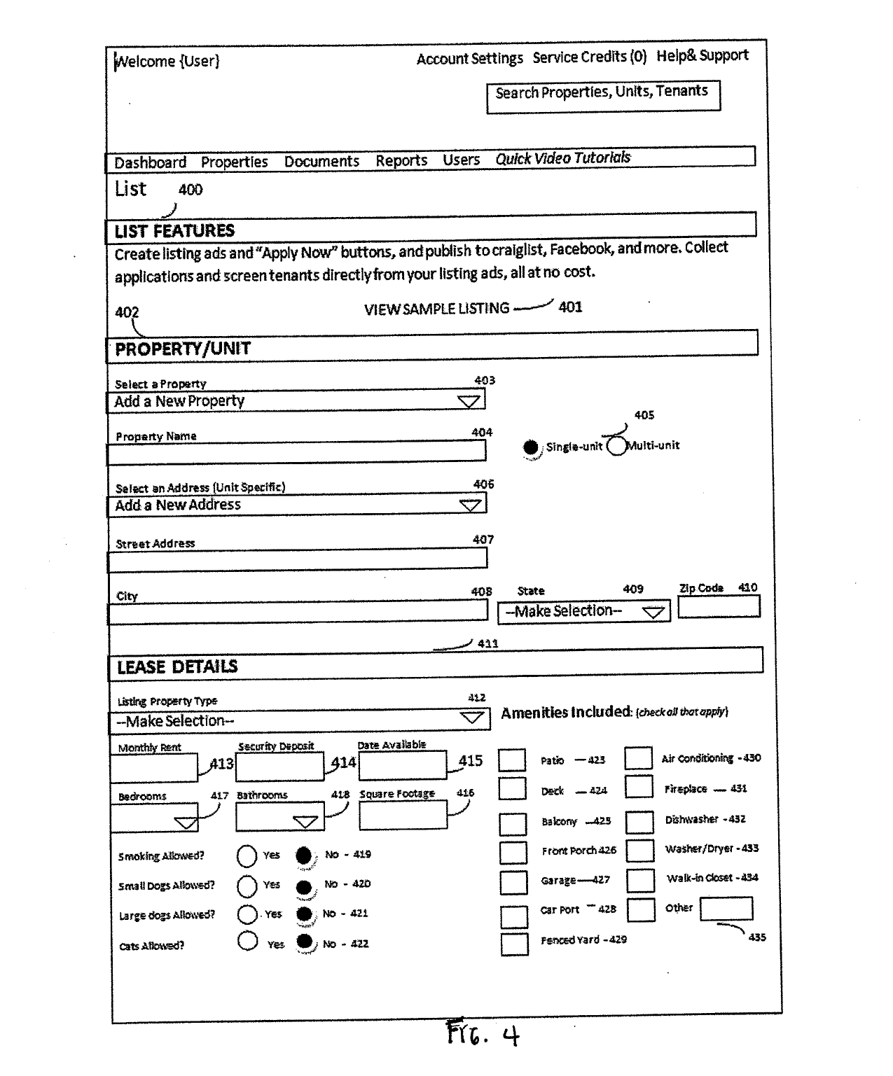

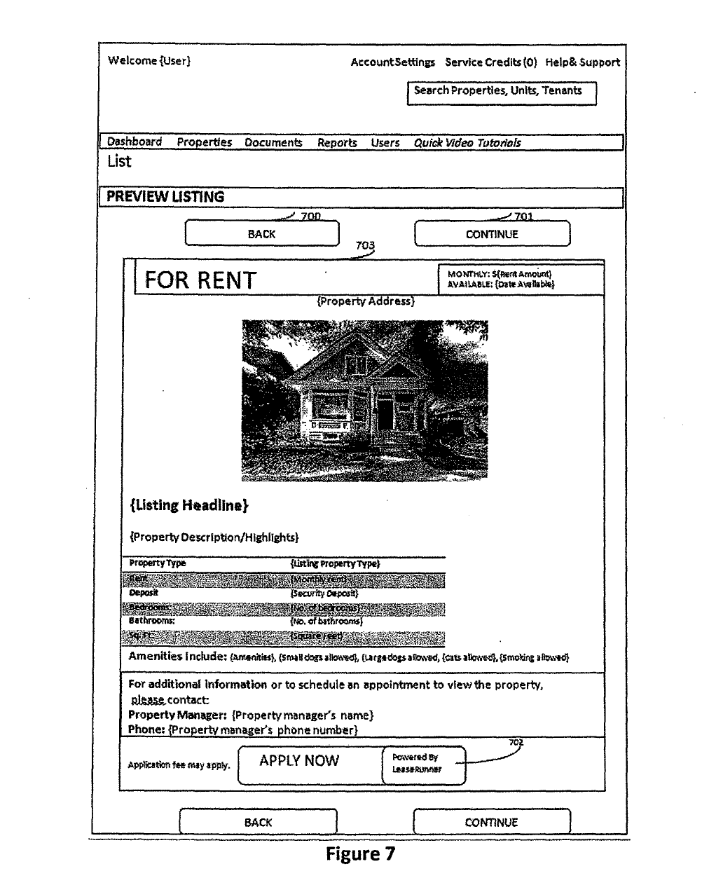

Listing Ad Data Input. Clicking the list action button 311 sends the Landlord 16 to a page to begin the ad creation process. FIG. 4 is a screenshot of an exemplary listing ad data input form, and the following paragraphs describe the sequential steps used for completion of the form. The form is broken into multiple sections of preferred data input fields. The purpose of the form is to collect the data from the Landlord 16 that will allow for the creation of an effective listing ad 703 (FIG. 7), allow for successful tenant screening by the Credit Reporting Agency 15, and allow the Landlord 16 to conveniently and effectively manage his or her properties using the website 11. Breaking the form into sections provides an organized structure and makes the form easier for the Landlord 16 to use. Sections may be added, deleted, or changed over time as needed. Section one provides list features and general instructions, and contains a link 401 to view a sample listing ad. Section two 402 contains data input fields related to the property and unit. Included is a dropdown menu 403 for the Landlord 16 to add a new property or choose an existing property from the database 14. The section contains a text field for the property name 404 and a radio button 405 for the Landlord 16 to select whether the property is a single-unit or multi-unit property. The section contains a dropdown menu for the Landlord 16 to choose a unit specific address 406. The section also contains text fields for the street address 407, city 408, and zip code 410; as well as a dropdown menu for the state 409. The property information is stored in the database 14. These property data input fields are not an absolute list and could change over time, as needed.

Section three 411 contains data input fields related to lease details and amenities. Included is a dropdown menu for the type of property 412. The section contains text fields for monthly rent 413, security deposit 414, date available 415, and square footage 416. The section contains dropdown menus for the number of bedrooms 417 and bathrooms 418. The section contains yes/no radio buttons for smoking allowed 419, small dogs allowed 420, large dogs allowed 421, and cats allowed 422. The section contains checkboxes for the following amenities: patio 423, deck 424, balcony 425, front porch 426, garage 427, car port 428, fenced yard 429, air conditioning 430, fireplace 431, dishwasher 432, washer/dryer 433, walk-in closet 434, and other amenities 435 as listed by the Landlord 16. The lease details and amenities data are stored in the database 14. The lease details and amenities data input fields listed in this section are not an absolute list and could change over time as needed.

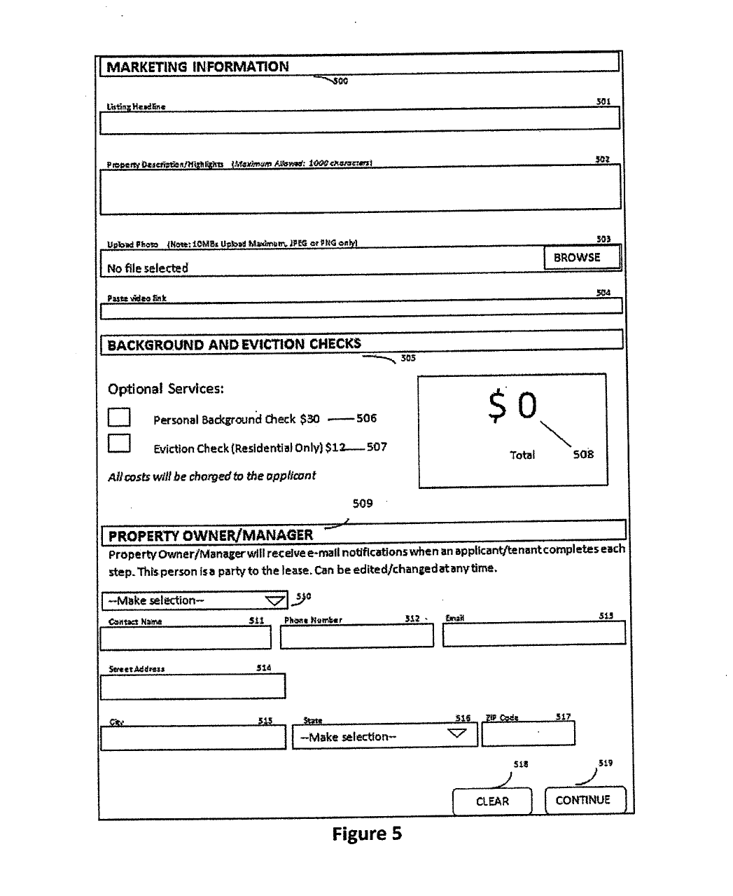

FIG. 5 is a screenshot showing sections four 500, five 505, and six 509. Section four 500 contains marketing data input fields. The section includes a listing headline text field 501 and a property description text field 502. The section also contains a photo upload function 503, allowing the Landlord 16 to choose a photo to be uploaded, optimized, inserted into the listing ad 703, and stored in the database 14. The section also contains a YouTube® video link upload 504, allowing the Landlord 16 to link a property video to the listing ad 703. The video link is stored in the database 14. This section preferably includes functionality to upload multiple photos, link multiple videos, or provide other multi-media content. The marketing data input fields listed in this section are not an absolute list and could change over time as needed.

Section five 505 contains tenant screening choices for the Landlord 16. Included are separate checkboxes for personal background check 506 and eviction check 507. A personal background check comprises a comprehensive credit and criminal report on a Renter 18. An eviction check comprises a nationwide eviction search on a Renter 18. Also displayed are the individual prices for the screening services, which are specific to the Landlord's 16 account. The application software 12 calculates the total amount of the fees from the checked boxes and displays the total amount in a summary box 508. All fees are charged directly to the Renter 18 when the Renter 18 submits a rental application. If no tenant screening box 506,507 is checked, the application software processes a free application without any tenant screening services. The Landlord's 16 screening choices are stored in the database 14. The tenant screening choices listed in this section are not an absolute list and could change over time as needed.

Section six 509 contains property owner or manager data input fields. Included is a dropdown menu 510 for the Landlord 16 to select an existing owner or manager or to create a new owner or manager and associate him or her with the property. Text fields exist for contact name 511, phone number 512, email address 513, street address 514, city 515, and zip code 517. Another dropdown form exists for the state selection 516. The property owner or manager data are stored in the database 14. The property owner or manager information listed in this section is not an absolute list and could change over time as needed.

Beneath section six are two buttons: clear 518 and continue 519. Clicking “clear” 518 allows the Landlord 16 to clear the form data, while clicking “continue” 519 stores the data from the sections described above in the database 14 and transfers the Landlord 16 to another page that allows the Landlord 16 to crop the photo chosen for upload described above.

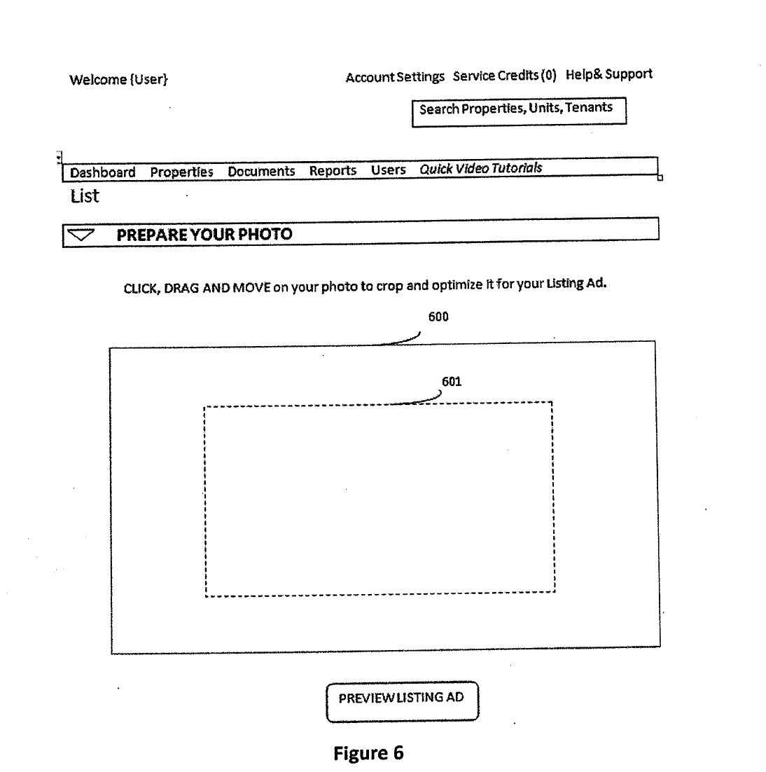

FIG. 6 is a screenshot of an exemplary photo optimize page. Approving the cropped photo 601 stores an optimized version of the cropped photo 601 in the database 14 and forwards the Landlord 16 to a preview of the listing ad 703.

Ad Preview. After completing the listing ad data form and approving the cropped and optimized photo upload, the application software 12 takes the form data stored in the database 14 and generates the listing ad 703 (FIG. 7) for the Landlord 16 to review and approve.

FIG. 7 is a screenshot of an exemplary page that displays the listing ad preview 703. This page allows the Landlord 16 to review the listing ad 703 for any desired changes. If the Landlord 16 desires to make a change, the Landlord 16 may click the “back” button 700, return to the list data form, make desired changes, and re-generate the ad containing the desired changes. The review process preferably allows the Landlord to adjust the format and appearance of the ad, directly in the listing preview page.

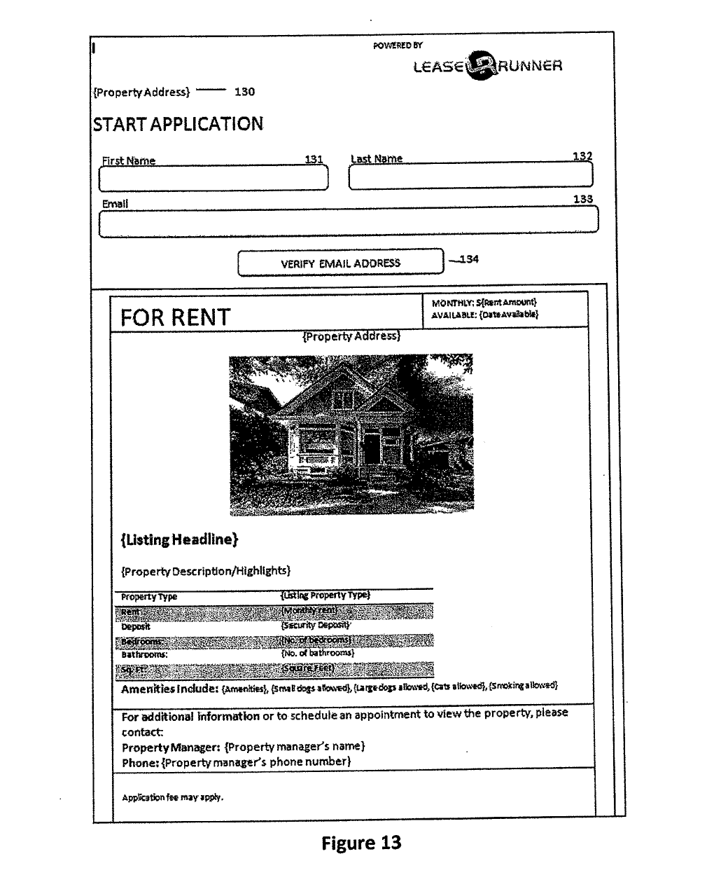

The listing ad 703 contains a button 702 that reads “Apply Now”. The technology and processes behind this button are notable. The button allows a Renter 18 to submit an application and screening report directly from the listing ad 703. The “Apply Now” button 702 is an image comprised of HTML code with two very important URL links. The first URL link takes the Renter 18 to the destination webpage, once the image is clicked. The application software generates this URL link, connecting many data points from the database 14 in order to facilitate application and screening from the listing ad 703. FIG. 13 is an exemplary destination webpage which allows the Renter 18 to start the application and tenant screening process. The second URL link is to the image source for the button, which gives the button its graphical appearance in the Renter's web browser. The second link allows the system 10 to display a consistent “Apply Now” button image, even as the destination URL link changes for each property and unit. Both links are hosted on the servers 13 and stored in the database 14. Thus, no matter where the listing ad 703 is posted on the internet, it remains connected to the servers 13. This constant connection allows for the application software 12, servers 13, and database 14 to connect the necessary parties involved in rental application and tenant screening and allow for a continuous and efficient rental application process for both the Landlord 16 and Renter 18.

It is the technology and processes behind the “Apply Now” button 702 that provide advantageous functionality to the present invention, not the design or text of the button. The design and text of the “Apply Now” button 702 could be changed as needed. For example, the size, shape, or color of the button could be changed as needed. Furthermore, the text of the button could be changed from “Apply Now” to “Apply Here” or to other text as needed. In another embodiment of the present invention, the application and screening URL link could be displayed in a listing ad 703, rather than the image button 702. This URL link could also be renamed, as well.

The ad preview page of FIG. 7 also contains a “continue” button 701. Clicking on the “continue” button 701 initiates several important processes. It generates the necessary URL links discussed in the previous paragraphs and activates the links so that Renters 18 may submit applications and screening reports directly from the listing ad 703. The URL link is stored in the database 14. To approve the listing ad, the Landlord 16 clicks the “continue” button, and the Landlord 16 proceeds to the post-your-listing page.

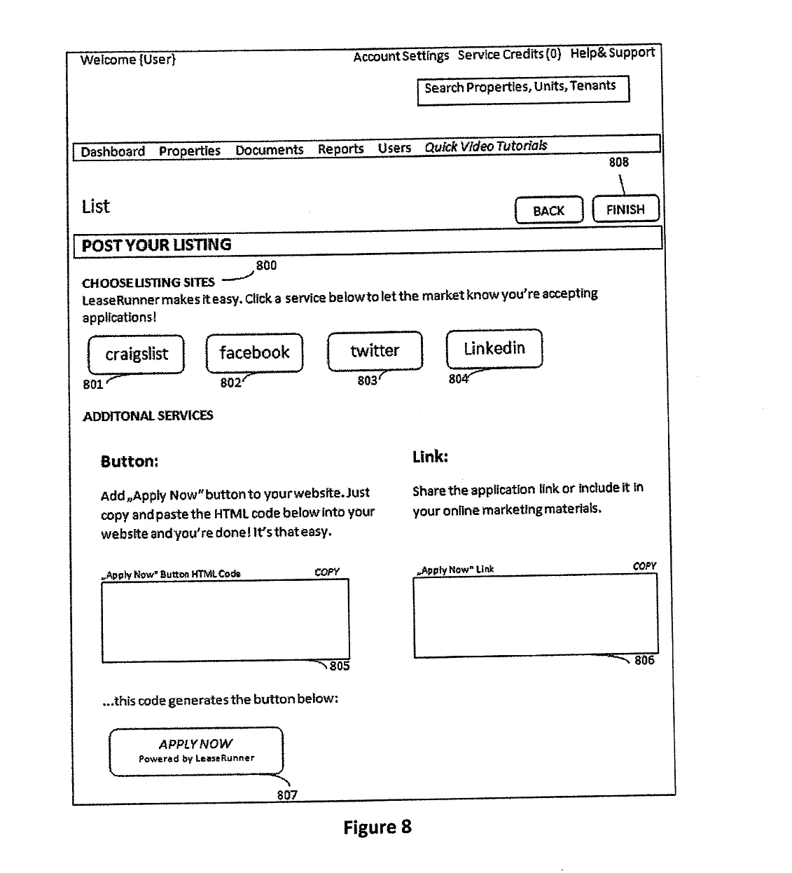

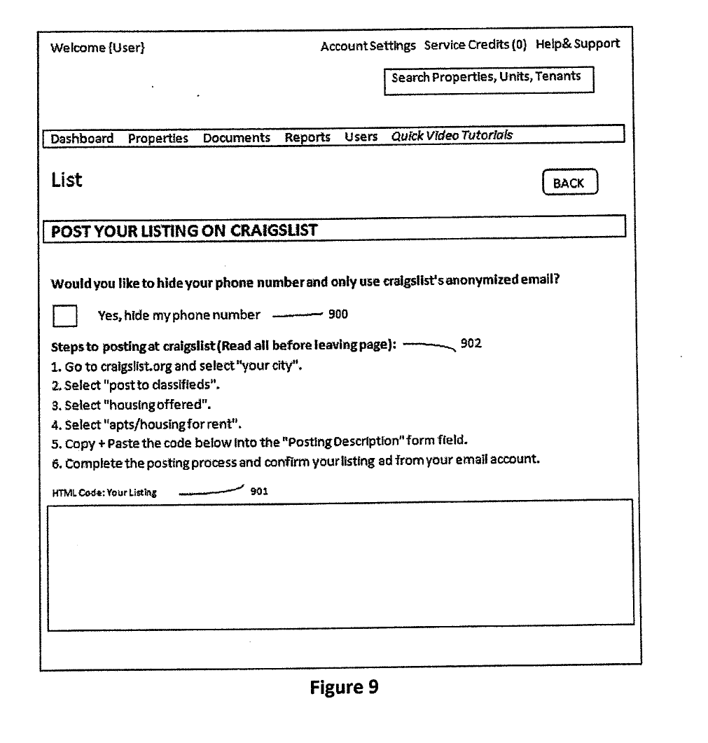

Posting the Listing Ad. FIG. 8 shows a screenshot of the post-your-listing page. The post-your-listing page allows the Landlord 16 to post the listing ad 703 he or she just created to Listing Portals 17. The listing ads 703 contain an “Apply Now” button 702 that will allow the Renter 18 to submit applications and tenant screening reports directly from the listing ads 703. Under the “choose listing sites” heading 800 are links for Craigslist® 801, Facebook® 802, Twitter® 803, and LinkedIn® 804. Preferably, this section will contain links to more Listing Portals. To post to craigslist.org, the Landlord 16 clicks on the “craigslist” button 801 and is taken to a page containing specific instructions 902 and HTML code 901 for posting to craigslist.org, as shown in the screenshot of FIG. 9. The code 901 is generated automatically by the application software 12, and it is unique for each listing ad. The code 901 creates a listing ad in craigslist.org that resembles that listing ad 703 created in prior steps, and it includes the “Apply Now” button 702 and functionality as described previously. The application software 12 automatically removes the Landlord's 16 email address from the HTML listing ad code to preserve the Landlord's 16 anonymity. Furthermore, the Landlord 16 may select a checkbox 900 causing the application software to automatically remove the Landlord's 16 phone number from the HTML listing ad code 901. The Landlord 16 copies and pastes the code into the appropriate form field in craiglist.org, as described in the instructions on the page FIG. 9. The instructions 902 and code 901 will change over time as craigslist's website and coding standards change. The application software 12 allows for the Landlord to post the listing ad data and the URL links discussed above to specific social media outlets by clicking on the buttons for Facebook® 802, Twitter® 803, and LinkedIn® 804. The application software follows the posting protocols recommended by these social media outlets, and the posting protocols may change over time. In the preferred embodiment, the application software 12 connects to other social media outlets through the protocols established by those outlets.

The application software 12 allows for the listing ad data and the URL links discussed above to be mapped according to specific XML, HTML, and RSS markup and to be shared via specific listings or generic marketing channels, including listing ads displayed by Listing Portals 17. Included in the XML, HTML, and RSS markup are the “Apply Now” button 702 HTML code, along with the destination and image source URL links The “Apply Now” button 807 HTML code and the “Apply Now” link 806 code can be included in XML, HTML, and RSS markup and shared. The website 11 provides two additional services that allow the Landlord 16 to post “Apply Now” buttons and links to any HTML webpage. Under the first service, the Landlord 16 can copy and paste the “Apply Now” button HTML code 805 into any HTML file. Doing so adds only the “Apply Now” button 807 to a webpage without the other listing ad data 703. This “Apply Now” button 807 functions the same way as the “Apply Now” button 702 from the listing ad 703. Under the second service, the Landlord 16 can copy and paste the “Apply Now” link code 806 into any HTML website, emails, documents, spreadsheets, and many other mediums where the application and screening function is used, but the button image (702, 807) is not displayed. Preferably, the system 10 can be altered to include other posting formats. Furthermore, the design and function of the buttons (702, 807) and link 806 may be changed as needed.

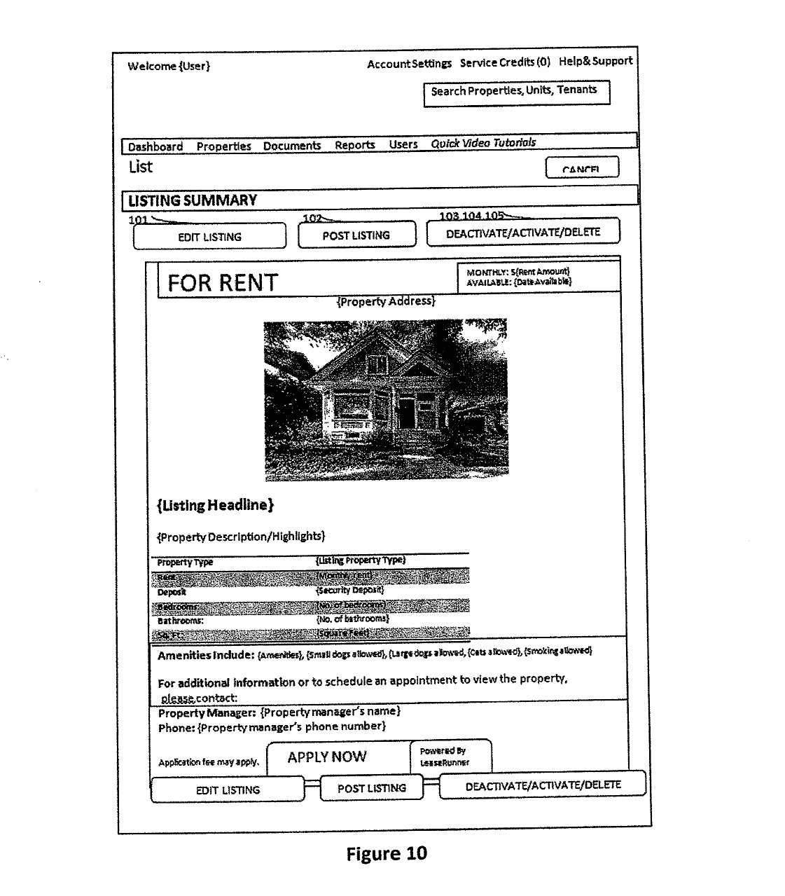

The Listing Summary. When the Landlord 16 completes posting the listing ad 703 and “Apply Now” button (805, 807) and link 806, he or she can complete the listing ad process by clicking the “finish” button 808 and returning to the dashboard FIG. 3. The Landlord 16 can access the listing ad summary FIG. 10 from the active listings table 317 on the dashboard, as well as from the Unit Details page under the Properties tab 306. Clicking on the links provided in these locations takes the Landlord 16 to a listing summary page FIG. 10.

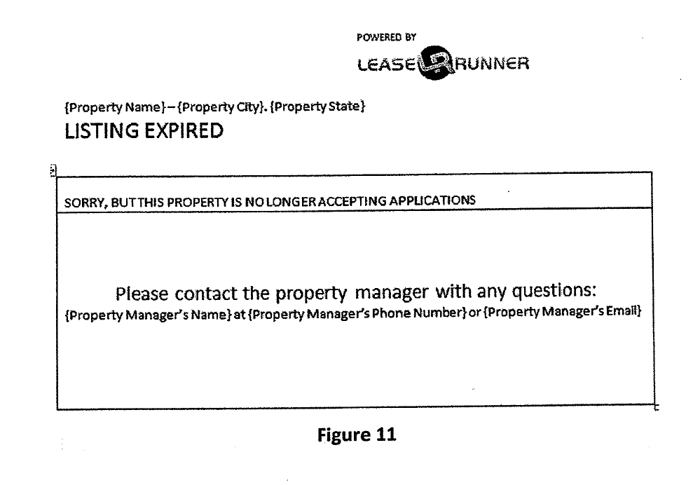

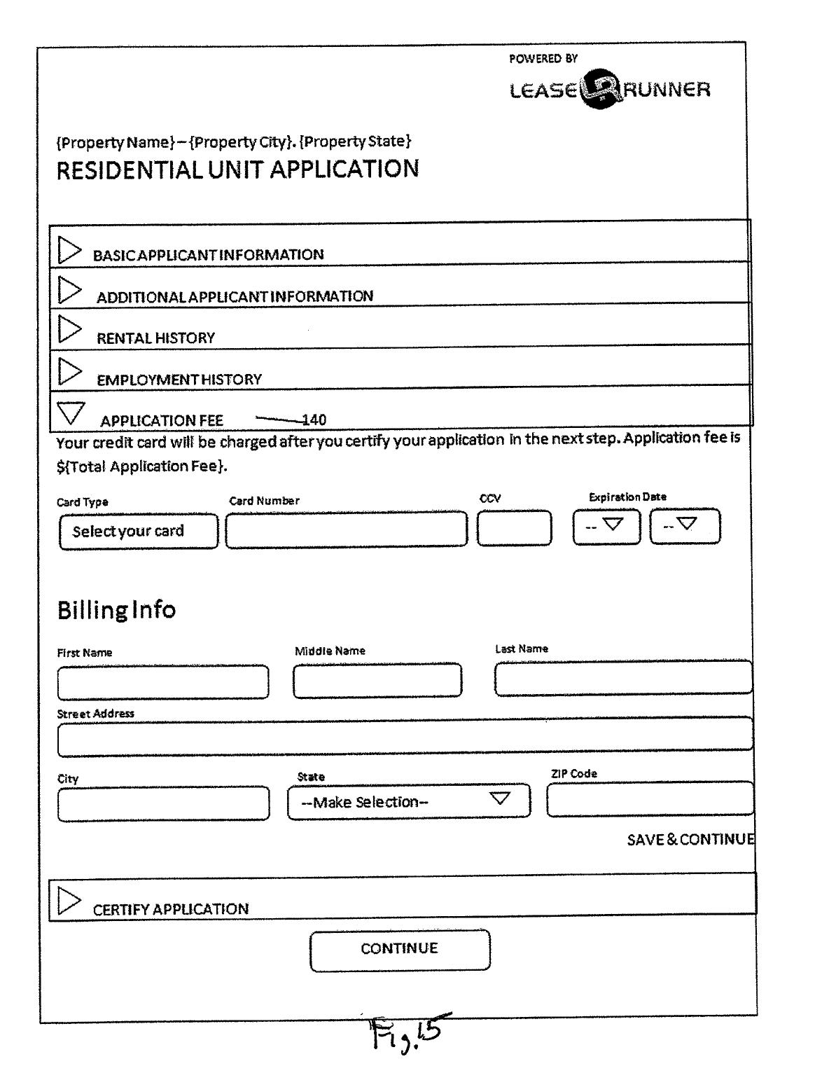

This listing summary page contains three main buttons: edit listing 101, post listing 102, and deactivate listing 103. Clicking on the “edit listing” button 101 takes the Landlord 16 to the list data form (FIG. 4, FIG. 5), where the Landlord 16 can edit the listing data. Clicking on the “post listing” button 102 takes the Landlord 16 back to the post-your-listing page as shown in FIG. 8, where the Landlord 16 can post the listing ad 703 to the Listing Portals 17. Clicking on the “deactivate listing” button 103 deactivates the application and screening URL link associated with an “Apply Now” button 702 in a listing ad, “Apply Now” button individually 807, and the “Apply Now” link 806. This is a notable feature of the preferred embodiment. Deactivating the application and screening URL link allows the Landlord 16 to stop receiving rental applications and screening reports for the property and unit associated with the listing ad. This allows the Landlord 16 to control the application flow received from the listing ads. When a Landlord 16 deactivates a link, the application software changes the webpage associated with the “Apply Now” button (702, 807) or link (806). Instead of presenting the Renter 18 with an application form FIG. 15, the application software 12 presents the Renter 18 with a webpage with a message that the Landlord 16 is no longer accepting applications. An exemplary webpage is shown in FIG. 11. The webpage is hosting on the servers 13. The content of the webpage message may change as needed.

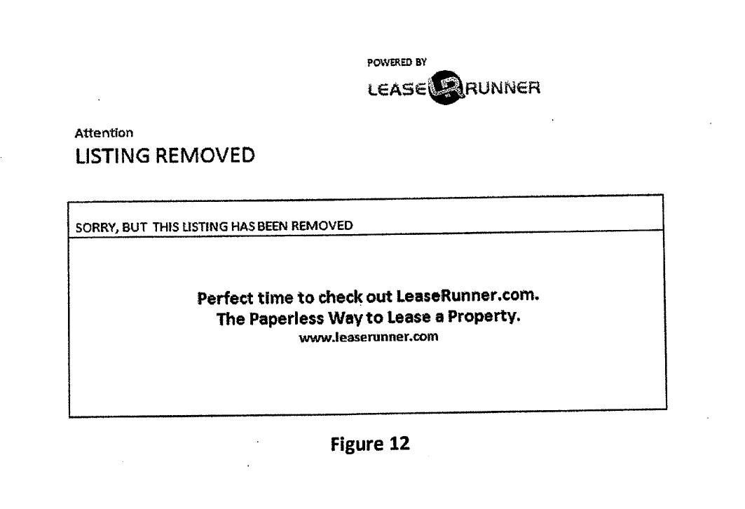

By clicking the “activate” button 104, the Landlord 16 may reactivate a listing ad application and screening URL link that the Landlord 16 had previously deactivated. The application software 12 allows the Landlord 16 to deactivate and activate an application link URL any number of times, as needed. Once an ad has been deactivated, a Landlord 16 may delete the listing ad 703 from the servers 13. Clicking “delete” 105 clears the listing ad data from the database. Once a listing ad has been deleted, the application software 12 again changes the webpage associated with the “Apply Now” button (702, 807) and URL link 806 with a message stating that the listing ad has been removed. An exemplary webpage is shown in FIG. 12. The webpage is hosting on the servers 13. The content of the webpage message may change as needed.

Giving the Landlord 16 the ability to activate, deactivate, and delete listing ads and their associated application and screening buttons and links is an important aspect of the preferred embodiment. A Landlord 16 may post many listing ads throughout the internet, and some of those listing ads might be reposted by others as well. The buttons and links might remain on internet web pages long after the Landlord 16 has rented the property. The application software gives the Landlord 16 the ability to control the functionality of application and screening buttons and links, no matter where they reside on the internet.

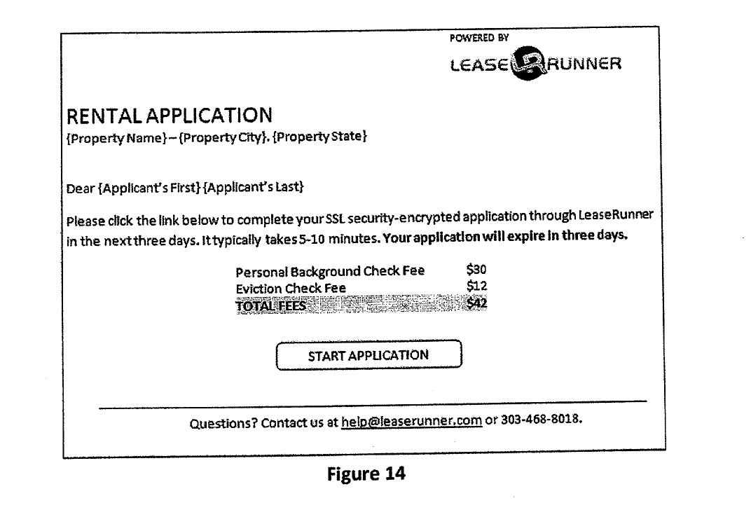

The ad and Application and Screening Function. This section describes how the listing ads 703 function from the Renter's 18 perspective, and how the Renter 18 submits his or her application and tenant screening report to the Landlord 16. When viewing a listing ad 703 on the internet, the Renter 18 can click on the “Apply Now” button (702,807; FIGS. 7 and 8) or link 806 to start the application process. The link takes the Renter 18 to a page titled “Start Application” that displays the address of the rental property and the listing ad. An exemplary page is shown in FIG. 13 and the page is hosted on the servers 13. The page also displays a form containing text fields for first name 131, last name 132, and email address 133. The form contains a submit button for the Renter to verify his or her email address 134. Once the Renter 18 clicks “verify email address” 134, the application software 12 stores the name and email address in the database 14 and performs processes that generate a unique application and screening URL link specific to the Renter 18 and property. The application software 12 emails the Renter 18 the link to the application. An exemplary email is shown in FIG. 14. The Renter 18 clicks on the application link in the email and is taken to the rental application. FIG. 15 shows an exemplary rental application. The application and screening URL link is hosted on the servers 13.

The functionality behind the start application page of FIG. 13 is an important aspect of the preferred embodiment. Preferably, the processes performed by the application software 12 for the start application page of FIG. 13 allow multiple unique applications to be submitted from one listing ad. Without this technology, the relationship between listing ad to applications would be one to one. Furthermore, the processes behind the start application page reduce the occurrences of applications submitted by bots, reduce spam, reduce load on the servers, and perform other security benefits.

The application software 12 stores the application data in the database 14. If the Landlord 16 selected any tenant screening services while creating the ad, the Renter 18 must pay for the tenant screening services via credit card before the process can continue 140. The credit card is validated and processed through a payment gateway, such as Authorize.net, on servers that are outside of the system 10.

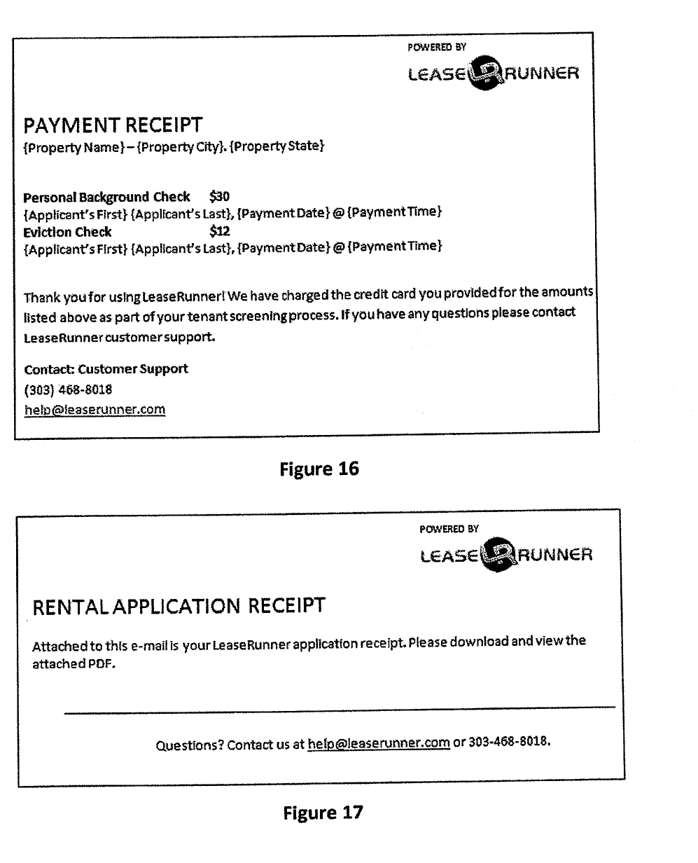

The application software 12 holds the submission process until either successful payment, deactivation of the application link by the Landlord 16, or expiration of the application link by the system. Upon confirmation of successful payment by the payment gateway, the application software 12 emails the Renter 18 a receipt of payment FIG. 16 and a PDF copy of the submitted application FIG. 17. The system 10 also passes necessary data for tenant screening to the appropriate Credit Reporting Agency 17. A preferred component of the preferred embodiment is an API connection between the servers 13 and two Credit Reporting Agencies 17: TransUnion and Background Data Solutions. However, other Credit Reporting Agencies 17 may be added to this list or even replace these two Credit Reporting Agencies

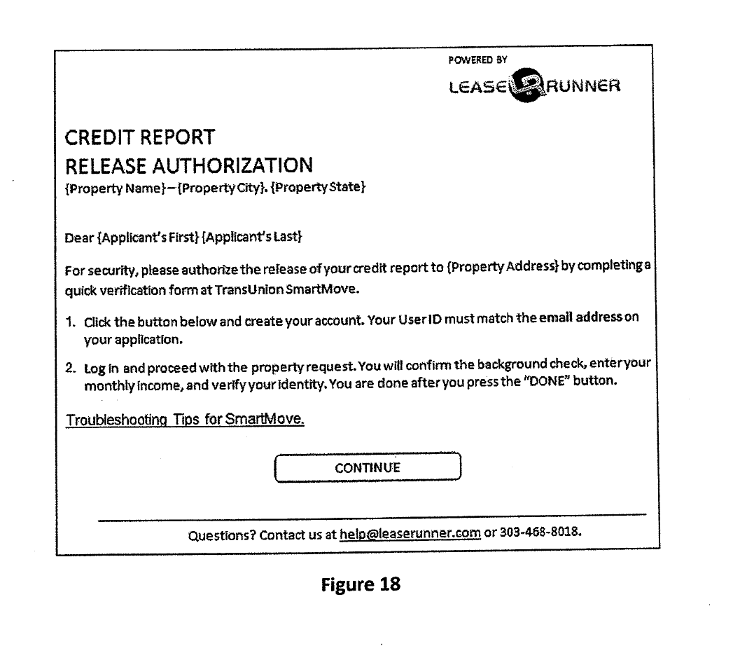

For a personal background check screening request, the system 10 transfers necessary data and a request for personal background check report to a Credit Reporting Agency 17, in this case TransUnion's SmartMove® system, which is a service that allows the Renter 18 to release a personal background check report to a landlord. The system then emails the Renter 18 instructions for authorizing release of the background check and a link to SmartMove, as shown in FIG. 18. The Renter 18 preferably logs into SmartMove® at www.mysmartmove.com and authenticates his or her identity. The screening request from the application software is waiting for the Renter 18 to approve. The Renter 18 releases the report data, which is sent to the servers 13 in XML format. The application software 12 parses and formats the XML data and creates an easy to read personal background check report for the Landlord 16 to view while logged into the website 11. The application software 12 then emails the Landlord 16 that the background check is ready for his or her review.

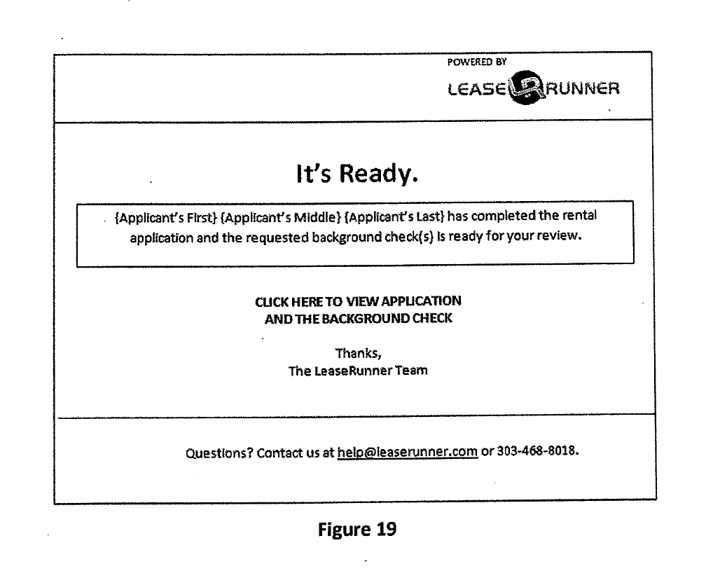

FIG. 19 shows an exemplary email to the Landlord 16. The Landlord 16 views the background check by logging into the website. Preferably, a more direct connection can be made between the system and SmartMove® or another Credit Reporting Agency, so that the Renter 18 can authenticate his or her identity and release the personal background check report without the need to log into SmartMove® or another Credit Reporting Agency. For an eviction check screening request, the application software 12 transfers the necessary data and a request for an eviction report to the Credit Reporting Agency 15, in this case Background Data Solutions. Background Data Solutions processes the data and request, and transmits the eviction report data back to the servers 13. The application software 12 parses and formats the data and creates an eviction check report. The application software 12 then emails the Landlord 16 that the eviction check is ready for his or her review. The Landlord 16 views the background check by logging into the website 11.

A Summary of the Connections. It is useful to summarize the connections between the parties, as shown in FIG. 1, and the data that is exchanged between the parties for the purpose of creating listing ads and accepting applications and screening directly from the listing ads 703. Landlords 16 log in to the website 11 and input data in order to build listing ads 703. The application software 12 and servers 13 post the listing ads 703 to Listing Portals 17, and the Landlord 16 can post listing ads to Listing Portals 17 manually, as well. Renters 18 view listing ads 703 on the Listing Portals 17, and Renters 18 can initiate applications and screening by clicking the “Apply Now” buttons (702, 807) or link 806 on the listing ads 703. Doing so connects the Renters 18 to the servers 13 and stores data in the database 14. The application software 12 and servers 13 email receipts to the Renter 18 and send background check requests to the Consumer Reporting Agencies 15. The Consumer Reporting Agencies 15 send background and eviction check data back to the servers 13. For personal background checks, the Renters 18 log in to the Consumer Reporting Agency 15, authenticate the Renter's identity, and release background check information from the Consumer Reporting Agency 15 to the servers 13. Finally, the application software 12 emails the Landlord 16 that the application and screening reports are ready for review, and the Landlord 16 logs in to the website 11 to view the reports.

Remaining Property Management Services. By creating a listing ad 703, the Landlord 16 stores data about the property in the database 14. Likewise, as Renters 18 complete applications and screening, data about the tenant is stored in the database 14. All of this data is available in the system 10 for use with the other property management services, should the Landlord 16 choose to use these services. The system's 10 services include listing ads, digital applications, tenant screening, auto-population and e-signature of lease documents, and electronic collection of rent. However, the service offerings could be expanded.

While the foregoing detailed description has described particular preferred embodiments of this invention, it is to be understood that the above description is illustrative only and not limiting of the disclosed invention. While preferred embodiments of the present invention have been shown and described herein, it will be obvious to those skilled in the art that such embodiments are provided by way of example only. Numerous variations, changes, and substitutions will now occur to those skilled in the art without departing from the invention.

What is claimed is:

1. Apparatus performing automatic tenant screening from an on-line rental listing ad, comprising:
an internet server having:
an interface to receive information from and to provide information to (i) an on-line tenant server and (ii) an on-line third party tenant screening server;
a memory storing details of at least one rental property;
at least one processor configured to (i) provide to the on-line tenant server one or more web pages showing the stored details of the at least one rental property, in response to an inquiry from the on-line tenant server, (ii) receive from the on-line tenant server a screening request in response to a tenant request made through the one or more web pages, (iii) provide the tenant screening request to the third party tenant screening server, (iv) receive from the third party tenant screening server a screening-result, (v) provide to the tenant server the screening-result through the one or more web pages, and (vi) accept through the one or more web pages a tenant rental application corresponding to the stored details of the at least one rental property.

2. The apparatus according to claim 1, wherein said interface receives information from and provides information to an on-line landlord server, and wherein said at least one processor is configured to (vii) receive from the on-line landlord server the listing ad for the at least one rental property, (viii) store the received listing ad in the memory, and (ix) provide to the on-line landlord server the screening-result provided by the third party tenant screening server.

3. The apparatus according to claim 2, wherein said at least one processor is configured to provide to said on-line landlord server functionality which said on-line landlord server uses to provide to said interface at least one of: rental property listings, rental applications, screening requests, lease documents, and rent collection information.

4. The apparatus according to claim 3, wherein said at least one processor is configured to provide to said on-line tenant server a rental property listing having an “apply’ feature by which said on-line tenant server can provide an application to lease a rental property through the one or more web pages showing the stored details of the rental property.

5. The apparatus according to claim 4, wherein said at least one processor is configured to receive more than one application to rent the property through one web page showing the stored details of the rental property.

6. The apparatus according to claim 5, wherein said at least one processor is configured to provide links to a plurality of social media sites through the one web page showing the stored details of the rental property.

7. A computer-implemented method of performing automatic tenant screening from an on-line rental listing ad, comprising:
receiving information from and providing information to (i) an on-line tenant server and (ii) an on-line third party tenant screening server, through an internet server interface, each said server comprising one or more processors;
storing in an internet server memory details of at least one rental property;
at least one processor of the internet server (i) providing to the on-line tenant server one or more web pages showing the stored details of the at least one rental property, in response to an inquiry from the on-line tenant server, (ii) receiving from the on-line tenant server a screening request in response to a tenant request made through the one or more web pages, (iii) providing the tenant screening request to the third party tenant screening server, (iv) receiving from the third party tenant screening server a screening-result, (v) providing to the tenant server the screening-result through the one or more web pages, and (vi) accepting through the one or more web pages a tenant rental application corresponding to the stored details of the at least one rental property.

8. The method according to claim 7, wherein said interface receives information from and provides information to an on-line landlord server, and wherein said at least one processor (vii) receives from the on-line landlord server the listing ad for the at least one rental property, (viii) stores the received listing ad in the memory, (ix) provides to the on-line landlord server the screening-result provided by the third party tenant screening server.

9. The method according to claim 8, wherein said at least one processor provides to said on-line landlord server functionality which said on-line landlord server uses to provide to said interface at least one of: rental property listings, rental applications, screening requests, lease documents, and rent collection information.

10. The method according to claim 9, wherein said at least one processor provides to said on-line tenant server a rental property listing having an “apply’ feature by which said on-line tenant server can provide an application to lease a rental property through the one or more web pages showing the stored details of the rental property.

11. The method according to claim 10, wherein said at least one processor receives more than one application to rent the property through one web page showing the stored details of the rental property.

12. The method according to claim 11, wherein said at least one processor provides links to a plurality of social media sites through the one web page showing the stored details of the rental property.

13. The method according to claim 11, wherein said at least one processor provides to the on-line landlord server a rental application web page including a landlord-customizable tenant background check portion.

14. A computer-readable, non-transitory medium having program code which, when executed by one or more processors, causes the one or more processors to carry out automatic tenant screening from an on-line rental listing ad, comprising:
receiving information from and providing information to (i) an on-line tenant server and (ii) an on-line third party tenant screening server, through an internet server interface, each said server comprising one or more processors;
storing in an internet server memory details of at least one rental property;
at least one processor of the internet server (i) providing to the on-line tenant server one or more web pages showing the stored details of the at least one rental property, in response to an inquiry from the on-line tenant server, (ii) receiving from the on-line tenant server a screening request in response to a tenant request made through the one or more web pages, (iii) providing the tenant screening request to the third party tenant screening server, (iv) receiving from the third party tenant screening server a screening-result, (v) providing to the tenant server the screening-result through the one or more web pages, and (vi) accepting through the one or more web pages a tenant rental application corresponding to the stored details of the at least one rental property.

15. The computer-readable medium according to claim 14, wherein the program code, when executed by the one or more processors, causes the one or more processors to receive information from and provide information to an on-line landlord server, and wherein said at least one processor (vii) receives from the on-line landlord server the listing ad for the at least one rental property, (viii) stores the received listing ad in the memory, (ix) provides to the on-line landlord server the screening-result provided by the third party tenant screening server.

16. The computer-readable medium according to claim 15, wherein the program code, when executed by the one or more processors, causes the one or more processors to provide to said on-line landlord server functionality which said on-line landlord server uses to provide to said interface at least one of: rental property listings, rental applications, screening requests, lease documents, and rent collection information.

17. The computer-readable medium according to claim 16, wherein the program code, when executed by the one or more processors, causes the one or more processors to provides to said on-line tenant server a rental property listing having an “apply’ feature by which said on-line tenant server can provide an application to lease a rental property through the one or more web pages showing the stored details of the rental property.

18. The computer-readable medium according to claim 17, wherein the program code, when executed by the one or more processors, causes the one or more processors to receive more than one application to rent the property through one web page showing the stored details of the rental property.

19. The computer-readable medium according to claim 18, wherein the program code, when executed by the one or more processors, causes the one or more processors to provide links to a plurality of social media sites through the one web page showing the stored details of the rental property.

20. The computer-readable medium according to claim 14, wherein the program code, when executed by the one or more processors, causes the one or more processors to provide to the on-line landlord server a rental application web page including a landlord-customizable tenant background check portion.
